(19) United States
(12) Patent Application Publication
(10) Pub. No.: US 2007/0201591 A1
(43) Pub. Date: Aug. 30, 2007

(54) BTS span synchronization utilizing an external span qualification reference

(76) Inventors: Barry F. Knerr, Wheaton, IL (US); Charles D. Gavrilovich, Park Ridge, IL (US)

Correspondence Address: MOTOROLA, INC., 1303 EAST ALGONQUIN ROAD, IL01/3RD, SCHAUMBURG, IL, 60196, US

(21) Appl. No.: 11/364,114

(22) Filed: Feb. 28, 2006

(51) Int. Cl. H04L 7/00

(52) U.S. Cl. 375/365

(57) ABSTRACT

A base station configuration and method relating thereto are disclosed. A base station (130) for use with a mobile communications network can include a clock source (205) that generates a timing reference signal having a minimum level of accuracy and a transceiver (210) configured to receive a synchronization signal via a backhaul channel of the mobile communications network. The base station (130) further can include a comparator (225) configured to compare the synchronization signal with the timing reference signal. The transceiver (210) can send a notification indicating a measure of accuracy of the synchronization signal according to a result determined from the comparator (225).

### BACKGROUND OF THE INVENTION

1. Field of the Invention

The present invention generally relates to mobile communications and, more particularly, to calibration of a Base Transceiver Station (BTS) oscillator.

2. Background of the Invention

Modern mobile communications networks are built using several low power transmitters as opposed to a single higher power transmitter. Each low power transmitter is referred to as a Base Transceiver Station (BTS) or simply as a “base station.” The transmission range of each base station is referred to as a cell. A set of cells, and therefore a set of base stations, that receives synchronization signals from a common infrastructure node of a mobile communications network, such as a Digital Cross-Connect (DCC), is referred to as a cluster.

A base station communicates with the communications network through digital links called spans, and sometimes referred to as backhaul channels. Each base station in the cluster receives synchronization signals via a backhaul channel from a same DCC. Clusters of cells then are replicated throughout a coverage area.

Each base station contains transmitter and receiver technology as well as the aerials needed to communicate with mobile stations. As such, each base station can transmit information to a mobile station and receive information from a mobile station via a wireless communication link. The channel over which each base station communicates with a mobile station is defined by the frequency of the carrier signal and can be referred to as a radio channel.

The carrier signal typically is generated by a frequency synthesizer which is driven by, or includes, an oscillator. To meet presently accepted telecommunications standards, for example those set forth by ITU-T Rec. G.823/824, the carrier signal must not deviate from its intended frequency by more than ±50 parts per billion (ppb). The carrier signal oscillator is calibrated to meet these stringent requirements.

With the passage of time, however, the frequency of the oscillator may drift and require calibration to compensate for the drift. A standard practice has been to manually calibrate these oscillators on a periodic basis through the use of routine onsite visits by qualified technicians. Unfortunately, this practice can cost upwards of several hundred dollars per visit, per base station. When considered in light of the large number of base stations currently in operation, the cost becomes significant.

### SUMMARY OF THE INVENTION

The present invention relates to a base station for use with a mobile communications network. In one arrangement, the present invention can include a base station having a clock source that provides a timing reference signal with a minimum level of accuracy and a transceiver that receives a synchronization signal via a backhaul channel of the mobile communications network. The base station further can include a comparator that compares the synchronization signal with the timing reference signal. The transceiver can send a notification indicating a measure of accuracy of the synchronization signal according to a result determined by the comparator.

In another arrangement, the present invention can include a method of backhaul channel synchronization within a base station of a mobile communications network. The method can include comparing a timing reference signal with a synchronization signal of the mobile communications network and determining a measure of accuracy for the synchronization signal according to the timing reference signal. One or more other base stations in a same cluster as the base station can be selectively notified according to the measure of accuracy.

In yet another arrangement, the present invention can include a machine readable storage being programmed to cause a machine to perform the various steps described herein.

### BRIEF DESCRIPTION OF THE DRAWINGS

Preferred embodiments of the present invention will be described below in more detail, with reference to the accompanying drawings, in which:

FIG. 1 is a block diagram that depicts a mobile communication system that is useful for understanding the present invention;

FIG. 2 is a block diagram that depicts various aspects of a base station which are useful for understanding the present invention; and

FIG. 3 is a flowchart illustrating a method of base station span synchronization that is useful for understanding the present invention.

### DETAILED DESCRIPTION

While the specification concludes with claims defining the features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

The inventive arrangements disclosed herein relate to base station span synchronization. A technique is provided for determining whether a synchronization signal is of suitable quality to be used in calibrating a carrier signal oscillator of the base station. The synchronization signal, also called a timing signal, can be extracted or derived from a communication stream received from a mobile communications network.

The carrier signal oscillator, or oscillator, is used to generate the carrier signal needed to wirelessly communicate with one or more mobile base stations. Further, in accordance with the inventive arrangements disclosed herein, a base station, upon detecting that the synchronization signal is not of suitable quality, or is not qualified, can notify other base stations in the same cluster as well as alert an operator.

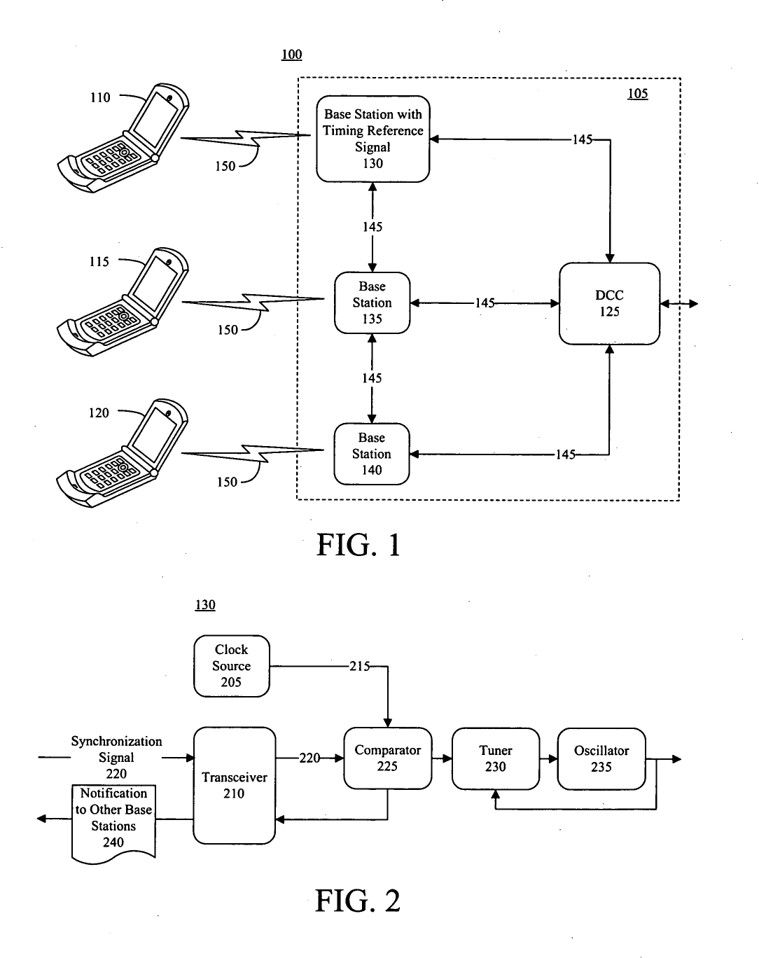

FIG. 1 is a block diagram that depicts a mobile communication system 100 that is useful for understanding the present invention. As shown, system 100 can include a cluster 105 and one or more mobile stations 110, 115, and 120. As known, the cluster 105 can include a mobile communications infrastructure node such as a Digital Cross-Connect (DCC) 125 as well as a plurality of base stations 130, 135, and 140.

DCC 125, in general, cross-connects same speed links, i.e., a T1 to T1 connection, an E1 to E1 connection, an STM1 to STM 1 connection, or the like. Each base station 130-140 has a backhaul channel (i.e. a span) 145 communicatively linking it with the DCC 125 and may have a backhaul channel 145 communicatively linking it with other base stations of cluster 105 as shown. As used herein, a backhaul channel can be a communication link between two network infrastructure nodes and, as such, can be a wired connection or a wireless connection.

Each of the base stations 130-140 can service one or more of the mobile stations 110-120 which may be located in any of the cells associated with one of the base stations 130-140. The base stations 130-140 communicate with the mobile stations 110-120 via radio links 150. A radio link 150 can be a wireless communication link between a network infrastructure node, such as one of the base stations 130-140, and a wireless communication device such as one of the mobile stations 110-120, which are not part of the network infrastructure.

To communicate information between the base stations 130-140 and the mobile stations 110-120 over radio links 150, each base station 130-140 utilizes a carrier signal of a specific nominal frequency. The carrier signal is used to define one or more channels. For any of the bases station 130-140 to be able to receive information transmitted from a mobile station 110-120 over a channel of a specific carrier frequency, the base station 130-140 must be capable of receiving signals at the expected frequency. For different channels not to disturb or interfere with one another, each carrier frequency must not deviate from its center frequency by more than a tolerable amount, which typically is within ±50 parts per billion (ppb).

Carrier signals usually are generated in a base station 130-140 using a synthesizer module. The synthesizer module is characterized by an oscillator of high stability in terms of the variance, or drift, of center frequency. The oscillator provides the reference signal from which carrier signal(s) can be generated or synthesized. Because the signal generated by the oscillator forms the synthesizer reference, the stability of the carrier signal is dependent upon the stability of the oscillator.

Rather than manually calibrate the carrier signal oscillator on a periodic basis, in accordance with the arrangements disclosed herein, the oscillator can be calibrated from a synchronization signal received from an infrastructure node of the mobile communications network. For example, the synchronization signal received from the DCC 125 over backhaul channel 145 can be used. Because of various network effects, the distance, and the number of nodes through which the synchronization signal typically travels to reach a base station, it may be the case that the synchronization signal lacks the accuracy needed to calibrate the oscillator. For such reasons, it becomes necessary to verify that the synchronization signal received has an accuracy of Stratum 2 or better. Once qualified, the synchronization signal can be used as a reference for purposes of calibrating the oscillator.

In this regard, base station 130 can include a timing reference source which can be used to verify and/or determine the accuracy of the synchronization signal received by the base station 130 over the backhaul channel 145 from DCC 125. In general, if the backhaul channel 145 provides a synchronization signal of suitable quality, as compared to the timing reference signal, the synchronization signal can be used to calibrate the oscillator of the base station 130.

In accordance with the arrangements disclosed herein, base station 130 further can be configured to send a notification signal to one or more other base stations, i.e., base stations 135 and 140 in cluster 105, in the event that the synchronization signal received over backhaul channel 145 is not of suitable quality. When other base stations 135-140 of cluster 105 receive the notification, each responsively can enter a free run mode. Further, base station 130 can send a notification to alert an operator that some sort of remedial action may be required to calibrate the carrier signal oscillator.

It should be appreciated that system 100 has been provided for purposes of illustration only and, as such, is not intended to limit the present invention in any way. For example, a lesser number of base stations can be included in cluster 105 or additional base stations can be included. Similarly, fewer mobile stations can be serviced or a larger number of mobile stations can be serviced, with the likelihood that a particular base station will service a plurality of mobile stations.

FIG. 2 is a block diagram that depicts various aspects of base station 130. Base station 130 can include a clock source 205 which can be used for purposes of qualifying or evaluating a synchronization signal. In one arrangement, clock source 205 can be external to the communications network in the sense that the timing reference signal 215 extracted and/or generated by the clock source 205 is not derived from a node of the mobile communications network.

In one arrangement, the clock source 205 can be a Global Positioning System (GPS) receiver capable of detecting and/or receiving a GPS steered clock. A GPS steered clock, for example, has an accuracy of ±0.01 ppb, which is sufficiently accurate to serve as a reference for comparing other timing signals. In another arrangement, the clock source 205 can be an atomic clock which generates, as output, the timing reference signal 215. Other examples of the clock source 205 can include a Rubidium, Cesium, or crystal-based clock, or any other clock source capable of providing a timing reference signal 215 having at least a minimum accuracy. To be useful in evaluating the accuracy of the synchronization signal, the timing reference signal should be rated Stratum 2 or better. In any event, the clock source 205 can be implemented as a receiver capable of receiving and extracting a timing reference signal or as a self-contained clock source that generates the timing reference signal.

The transceiver 210 is configured to receive communications via a backhaul channel from an infrastructure node of the mobile telecommunications network, such as the DCC 125 of FIG. 1. As noted, the backhaul channel may be either wired or wireless. In any case, the transceiver 210 can extract or identify a synchronization signal 220 from such communications. The synchronization signal 220, determined from the backhaul channel, can be compared with the timing reference signal 215 from clock source 205 using a comparator 225. The comparator 225 can be implemented as a microprocessor such as a Digital Signal Processor, a Field Programmable Gate Array or other programmable logic device, one or more discreet logic components, or any combination thereof.

Through a comparison of the timing reference signal 215 with the synchronization signal 220, comparator 225 can determine whether the synchronization signal 220 is a Stratum 2 or better quality signal in terms of frequency and drift. If the synchronization signal 220 is of sufficient quality, the synchronization signal 220 can be used for purposes of calibrating an oscillator 235 from which a carrier signal is derived within base station 130. In that case, the synchronization signal 220 can be provided to a tuner module 230 which can automatically calibrate the oscillator 235 using the synchronization signal 220 as a reference.

If the synchronization signal 220 is not of sufficient quality as determined by the comparator 225, the comparator 225 can signal the transceiver 210 to indicate that the synchronization signal is not of sufficient quality. In one arrangement, for example, the comparator can provide an error signal indicating the frequency and/or phase difference between the two signals to the transceiver 210. In another arrangement, the notification can simply be an indication that the synchronization signal is unsuitable. Accordingly, the transceiver 210 can send a message or notification 240 to one or more other base stations in the same cluster as base station 130 indicating that the synchronization signal 220 is not of sufficient quality for calibrating the carrier signal oscillator.

In one arrangement, the notification 240 can be sent to each other base station in the cluster. Responsive to receiving such a notification, each recipient base station can enter a free run mode. More particularly, each base station within the cluster, responsive to receiving a notification 240, will not utilize the synchronization signal 220 for calibrating its internal carrier signal oscillator and run in a free run mode.

Transceiver 210 further can send a notification or an alert to an operator. The alert informs the operator that the synchronization signal 220 cannot be used for purposes of automatically calibrating the carrier signal oscillator within the base stations of a given cluster. The operator then can cause further remedial action to be taken as may be required, e.g., causing a technician to be sent to manually calibrate the oscillator(s) or the like. The alert also can specify any measurements determined by the comparator 225.

The arrangements disclosed with reference to FIG. 2 have been provided for purposes of illustration. It should be appreciated that base station 130 can be implemented with varying hardware elements as may be required. For example, the transceiver 210 can be implemented as a single unit as shown, or as a combination of a plurality of units, i.e., at least one receiver and at least one transmitter. Further, since the backhaul channel(s) may be wired, wireless, or both, the transceiver 210 can be implemented as a wireless transceiver in the case of a wireless backhaul channel, as a network adapter in the case of a wired backhaul channel, or include components of each variety.

By equipping only a limited number of base stations, or in this case a single base station, within a given cluster with a clock source 205 as discussed herein, costs can be reduced. That is, rather than equipping each base station of a cluster with a clock source 205 and configuring each base station to perform its own evaluation of the synchronization signal 220, a single base station can be so equipped and configured to perform the evaluation. Results determined by the base station then can be passed along or propagated to each other base station within the cluster as an alert or notification, thereby alleviating the need to include a clock source 205 for each base station.

The arrangements disclosed herein also provide a level of flexibility in that not every base station in a cell will be located in a manner that allows the base station to receive a GPS signal. The present invention allows a base station disposed at a location that facilitates adequate GPS reception to be equipped with a GPS receiver and send notifications via backhaul channel(s) to other base stations that are unable or are less able to receive GPS or other timing reference signals.

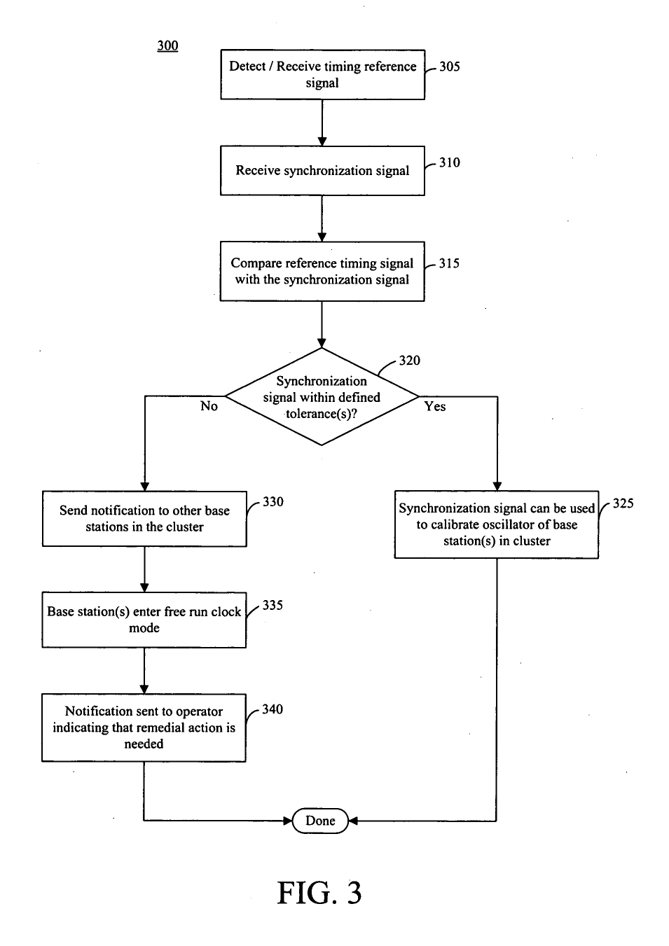

FIG. 3 is a flowchart illustrating a method 300 of base station span synchronization that is useful for understanding the present invention. Method 300 can be performed by a mobile communications network infrastructure node such as the base station described with reference to FIGS. 1 and 2. Method 300 can be performed on a periodic basis or from time to time as may be required when calibration of the carrier signal oscillator is deemed necessary.

Method 300 can begin in step 305 where a timing reference signal can be received and/or detected. As noted, the timing reference signal can be generated by a highly accurate and stable clock source disposed within the base station or can be received and extracted from a signal received from such a clock source that is external to the base station. In either case, the timing reference signal can have a quality level of Stratum 2 or better.

In step 310, the base station can receive or detect a synchronization signal from another node, such as an infrastructure node, of the mobile communications network. For example, the synchronization signal can be received via a backhaul channel from a DCC. In step 315, the base station can compare the timing reference signal with the synchronization signal to determine a measure of accuracy. The synchronization signal can be qualified using the timing reference signal by measuring differences in frequency, drift, phase, or the like.

Referring to decision box 320, a determination can be made as to whether the synchronization signal is qualified for use in calibrating the carrier signal oscillator within the base station. If the synchronization signal is within a predefined tolerance range, for example as may be specified by a mobile communication standard such as ITU-T Rec. G.823/824 or other applicable standard, the synchronization signal can be used. In one arrangement, the synchronization signal must have an accuracy of ±50 pbb.

If the synchronization signal is within the defined tolerance range, the method can proceed to step 325, where the synchronization signal can be used to calibrate the oscillator of the base station. Qualifying the synchronization signal as described effectively ensures that a synchronization signal obtained from a backhaul channel is suitably accurate and usable to tune an oscillator from which the carrier frequency is derived for use in radio communications with mobile stations.

If the synchronization signal is not within the defined tolerance range, the method can proceed to step 330. In step 330, the base station can send a notification to one or more other base stations in the same cluster. In one arrangement, the notification can be sent to each base station within the same cluster through one or more direct communication links with each other base station. As noted, such notification can be sent via backhaul channel(s), whether wired, wireless, or a combination of both.

In another arrangement, such notification can be sent from the base station to a management system such as an operations management center. The management system then, in turn, can signal the other base stations. In yet another arrangement, the notification can be sent to a mobile station, which can notify one or more other base stations in the same cluster via one or more radio link(s). In any case, the notification can indicate that the synchronization signal from the DCC is not of suitable quality for use in calibrating the oscillator. The notification effectively instructs the recipient base station(s) not to utilize the span synchronization signal from the DCC for oscillator calibration.

In step 335, each base station that receives such a notification can enter a free run mode. In free run clock mode, the base station can continue to run. The oscillator, however, is not calibrated using the synchronization signal. In step 340, the base station also can send a notification to an operator or other personnel indicating that remedial action is required. The operator, upon receiving such information from the base station, can schedule or request that service personnel visit the base station, and possibly other base stations in the same cluster, to calibrate the internal oscillator(s).

The arrangements disclosed herein provide a technique for evaluating the sufficiency of a synchronization signal obtained from a mobile communications network infrastructure node for purposes of calibrating a carrier signal oscillator. Based upon a comparison of the synchronization signal with a timing reference signal of known accuracy, alerts can be provided to other base stations in a same cluster, i.e. other base stations serviced by the same mobile communications network node from which the synchronization signal is obtained, as well as to service personnel.

The present invention can be realized in hardware, software, or a combination of hardware and software. The present invention can be realized in a centralized fashion in one processing system or in a distributed fashion where different elements are spread across several interconnected processing systems. Any kind of processing system or other apparatus adapted for carrying out the methods described herein is suited. A typical combination of hardware and software can be a processing system with one or more applications that, when being loaded and executed, control the processing system such that it carries out the methods described herein. The present invention also can be embedded in an application product, which comprises all the features enabling the implementation of the methods described herein, and which when loaded in a processing system is able to carry out these methods.

The terms “computer program,” “software,” “application,” variants and/or combinations thereof, in the present context, mean any expression, in any language, code or notation, of a set of instructions intended to cause a system having an information processing capability to perform a particular function either directly or after either or both of the following: a) conversion to another language, code, or notation; b) reproduction in a different material form. For example, an application can include, but is not limited to, a subroutine, a function, a procedure, an object method, an object implementation, an executable application, an applet, a servlet, a source code, an object code, a shared library/dynamic load library and/or other sequence of instructions designed for execution on a processing system.

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language).

This invention can be embodied in other forms without departing from the spirit or essential attributes thereof. Accordingly, reference should be made to the following claims, rather than to the foregoing specification, as indicating the scope of the invention.

What is claimed is:

1. A base station for use with a mobile communications network comprising:
a clock source that provides a timing reference signal having a minimum level of accuracy;
a transceiver that receives a synchronization signal via a backhaul channel of the mobile communications network; and
a comparator that compares the synchronization signal with the timing reference signal,
wherein the transceiver sends a notification indicating a measure of accuracy of the synchronization signal according to a result determined by the comparator.

2. The base station of claim 1, wherein the comparator determines a phase difference between the synchronization signal and the timing reference signal.

3. The base station of claim 1, wherein the comparator determines a frequency difference between the synchronization signal and the timing reference signal.

4. The base station of claim 1, further comprising a tuner that selectively calibrates, according to the measure of accuracy, an oscillator of the base station that is used as a reference to generate a carrier signal for radio link communications.

5. The base station of claim 1, wherein the transceiver sends the notification directly to at least one other base station in a same cluster.

6. The base station of claim 1, wherein the transceiver sends the notification to at least one other base station in a same cluster via an intermediate node of the mobile communications network.

7. The base station of claim 1, wherein the clock source is a Global Positioning System (GPS) receiver and the timing reference signal is a GPS timing signal.

8. The base station of claim 1, wherein the clock source is internal to the base station.

9. Within a base station of a mobile communications network, a method of backhaul channel synchronization comprising:
comparing a timing reference signal with a synchronization signal of the mobile communications network;
determining a measure of accuracy for the synchronization signal according to the timing reference signal; and
selectively notifying at least one other base station in a same cluster as the base station according to the measure of accuracy.

10. The method of claim 9, wherein determining a measure of accuracy further comprises calculating a phase difference between the synchronization signal and the timing reference signal.

11. The method of claim 9, wherein determining a measure of accuracy further comprises calculating a frequency difference between the synchronization signal and the timing reference signal.

12. The method of claim 9, further comprising selectively calibrating, according to the measure of accuracy, an oscillator of the base station that is used as a reference to generate a carrier signal for radio link communications.

13. The method of claim 9, wherein selectively notifying at least one other base station further comprises sending a notification to at least one other base station in a same cluster via a direct communication link.

14. The method of claim 9, wherein selectively notifying at least one other base station further comprises sending a notification to a mobile station, wherein the mobile station notifies at least one other base station in a same cluster.

15. The method of claim 9, wherein selectively notifying at least one other base station further comprises sending a notification to a management system, wherein the management system notifies at least one other base station in a same cluster.

16. A machine readable storage having stored thereon a computer program having a plurality of code sections comprising:
code for comparing a timing reference signal with a synchronization signal of a mobile communications network;
code for determining a measure of accuracy for the synchronization signal according to the timing reference signal; and
code for selectively notifying at least one other base station in a same cluster as the base station according to the measure of accuracy.

17. The machine readable storage of claim 16, wherein the code for determining a measure of accuracy further comprises code for calculating a phase difference between the synchronization signal and the timing reference signal or code for calculating a frequency difference between the synchronization signal and the timing reference signal.

18. The machine readable storage of claim 16, wherein the code for selectively notifying at least one other base station further comprises code for sending a notification to at least one other base station in a same cluster via a direct communication link.

19. The machine readable storage of claim 16, wherein the code for selectively notifying at least one other base station further comprises code for sending a notification to a mobile station, wherein the mobile station notifies at least one other base station in a same cluster.

20. The machine readable storage of claim 16, wherein the code for selectively notifying at least one other base station further comprises code for sending a notification to a management system, wherein the management system notifies at least one other base station in a same cluster.
